(19) United States
(12) Patent Application Publication
(10) Pub. No.: US 2007/0086088 A1
(43) Pub. Date: Apr. 19, 2007

(54) Projection screens

(75) Inventor: Gary James Astill, Leicester (GB)

Correspondence Address: YOUNG & BASILE, P.C., 3001 WEST BIG BEAVER ROAD, SUITE 624, TROY, MI, 48084, US

(73) Assignee: LASTOLITE LIMITED, Leicestershire (GB)

(21) Appl. No.: 10/580,359

(22) PCT Filed: Nov. 26, 2004
(86) PCT No.: PCT/GB04/04982

§ 371 Date: May 23, 2006

(30) Foreign Application Priority Data
Nov. 29, 2003 (GB) 0327819.9

(51) Int. Cl. G03B 21/56

(52) U.S. Cl. 359/443

(57) ABSTRACT

A projection screen is disclosed that includes a projection layer formed of a flexible sheet of fabric and means for supporting the projection layer in tension during use. At least part of the tensioned projection layer has a front projection surface adapted to have an image projected thereon and a corresponding rear surface that is overlaid with a backing layer that absorbs light transmitted through the projection surface of the projection layer.

### BACKGROUND OF THE INVENTION

This invention relates to projection screens and, in particular, to front projection screens having a projection surface formed by a flexible sheet of fabric supported in tension during use.

A front projection screen provides a surface for reflecting images projected onto it by a suitable projector, thereby allowing a viewer situated on the same side of the projection screen as the projector to view the projected images. Conventional front projection screens comprise a sheet of material having a front projection surface upon which images are projected, and being sufficiently flexible to be stored on a roller when not in use. The sheet of flexible material is conventionally formed of PVC, or fiberglass coated with PVC, and typically has a matt white projection surface. The projection surface may also be embossed with glass beads to improve the quality of the projected image within a narrow viewing angle. A disadvantage associated with such projections screens, however, is that even when the sheet of flexible material is stored on a roller, the projection screen is a bulky piece of apparatus. A need therefore existed for projection screens that were collapsible to a size more convenient for transportation.

Relatively recently, collapsible projection screens have been developed comprising a projection surface formed by a flexible sheet of fabric that is supported in tension during use. Such projection screens are collapsible to a much smaller size than is possible with conventional projection screens. However, a disadvantage associated with such projection screens is that the image quality may be reduced relative to the image quality of conventional projection screens having a matt white PVC projection surface.

### SUMMARY OF THE INVENTION

There has now been devised an improved projection screen which overcomes or substantially mitigates the above-mentioned and/or other disadvantages associated with the prior art.

According to the invention, there is provided a projection screen comprising a projection layer formed of a flexible sheet of fabric, and means for supporting the projection layer in tension during use, wherein at least part of the tensioned projection layer has a front projection surface adapted to have an image projected thereon and a corresponding rear surface that is overlaid with a backing layer that absorbs light transmitted through the projection surface of the projection layer.

The projection screen according to the invention is advantageous principally because, surprisingly, the provision of the backing layer has been found to improve the image quality of projection screens having a projection surface formed by a tensioned sheet of fabric. In particular, the contrast factor of the projected image may be higher than is the case for previously-known collapsible projection screens. Projection screens according to the invention therefore have high image quality as well as being collapsible to a convenient size for transportation.

By “fabric” is meant a material formed from threads or fibres of material, and that may be woven or knitted in form. Preferably, the tensioned projection layer is free of creases. For this reason, the projection layer is preferably formed of an elastic fabric, and is preferably stretched slightly when tensioned. Most preferably, the projection layer is formed of a knitted fabric. The front projection surface of the projection layer preferably comprises a rectangular area of white colouration. The remainder of the projection layer is preferably of black colouration.

The rectangular projection surface may have any suitable size but preferably has a diagonal dimension of between 0.3 m and 3 m, and most preferably between 0.5 m and 2.5 m. The diagonal dimension of the entire projection layer is preferably no more than 50%, and more preferably no more than 30%, greater than the diagonal dimension of the projection surface.

The backing layer overlies a rear surface of the projection layer that corresponds to the front projection surface so as to absorb light transmitted through the projection surface of the projection layer. Most preferably, however, the backing layer overlies the entire rear surface of the projection layer. The projection layer and backing layer are therefore preferably of similar dimensions. The backing layer is preferably of black colouration, and is preferably formed of a sheet of fabric. Most preferably, the backing layer is formed of a sheet of knitted fabric of black colouration.

The facing surfaces of the projection layer and the backing layer may be bonded together but, more preferably, the projection layer and backing layer are not bonded together but are held in close abutment. Most preferably, the backing layer is also supported in tension during use.

Preferably, the projection layer and the backing layer are both supported in tension by a flexible hoop, thereby forming a projection panel that can be very rapidly and easily collapsed and re-erected by relative twisting of opposite sides of the panel and folding. The projection screen can therefore be reduced to a much smaller effective size and stowed in a compartment or bag provided for the purpose.

Preferably, the projection layer and backing layer are provided with a peripheral tube within which the flexible hoop is accommodated, the hoop serving to tension and slightly stretch the fabric of the projection layer and preferably also the backing layer. The flexible hoop is most preferably formed of a band of resilient material, eg a flat strip of resilient material. The band is most preferably formed in a metal such as steel. The band preferably has a width of between 5 mm and 15 mm.

The projection screen may include means, such as one or more loops of material, by which the panel can be suspended during use. Most preferably, the projection screen includes two loops of material, one at each end of the upper edge of the panel.

The projection screen is preferably self-supporting in an upright position. In a presently preferred embodiment, the projection screen comprises one or more support panels that are similar to the projection panel but do not necessarily have a projection surface or a backing layer. Such support panels preferably enable the projection screen to be self-supporting in an upright position. Preferably, the projection screen is arranged to be collapsible by firstly folding the projection screen so that the projection and support panels overlie one another, and then twisting opposite sides of the overlaid panels relative to one another and folding. It is particularly preferred that the panels should not be connected directly together, but should be separated by a flexible web or gusset interposed between adjacent edges of the panels. The provision of such connecting webs facilitates folding of the panels when it is desired to collapse the apparatus for storage or transportation.

The projection screen may include a stabilising member disposed between the projection panel and a support panel in order to improve the stability of the self-supporting projection screen. Such a stabilising member may be made of a flexible material but preferably takes the form of a rigid stabilising member. In the case of a rigid stabilising member, the stabilising member preferably comprises two rigid arms that are hingedly attached to one another. The member preferably further includes means for fixing the position of the arms relative to one another when the projection screen is erect.

### BRIEF DESCRIPTION OF THE DRAWINGS

The invention will now be described in greater detail, by way of illustration only, with reference to the accompanying drawings, in which

FIG. 1 is a perspective view of a first embodiment of a projection screen according to the invention;

FIG. 2 is a cross-sectional view of part of the projection screen of FIG. 1;

FIG. 3 shows perspective views of a stabilising member forming part of the projection screen of FIG. 1;

FIG. 4 shows stages in the collapse of the projection screen of FIG. 1 for storage; and

FIG. 5 is a perspective view of a second embodiment of a projection screen according to the invention.

### DETAILED DESCRIPTION

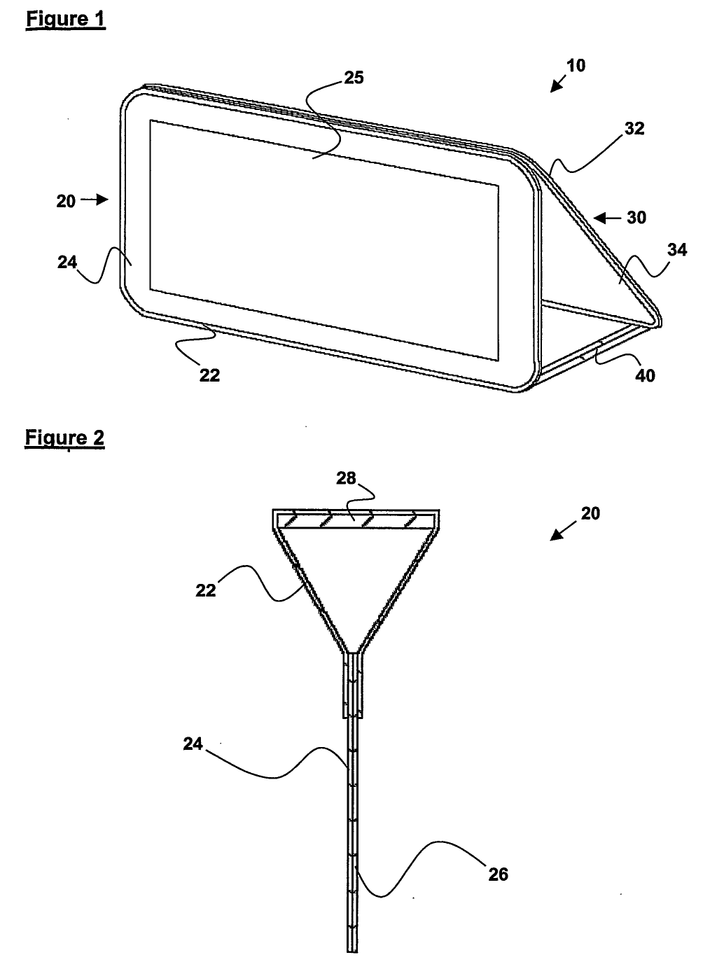

Referring firstly to FIG. 1, a first embodiment of a projection screen according to the invention is shown and generally designated 10. The projection screen 10 comprises a front panel 20, a rear panel 30 and two rigid stabilising members 40, one at each end of the projection screen 10 (only one member 40 being visible in FIG. 1). The front and rear panels 20,30 are of generally rectangular shape with rounded corners. The front and rear panels 20,30 are connected at a major edge (the top as viewed in FIG. 1) by a narrow gusset of approximate width 2 cm. The gusset is formed from a flexible fabric material, thereby allowing the opening and folding of the projection screen 10.

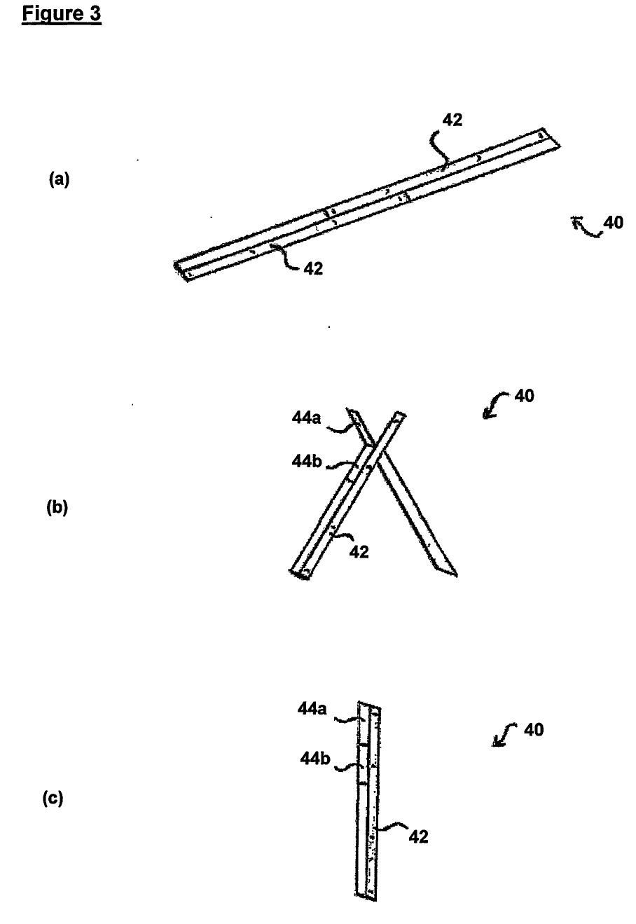

FIG. 2 shows a cross-sectional view of a peripheral portion of the front panel 20. The front panel 20 comprises a front sheet 24 and a rear sheet 26 of knitted fabric. The front and rear sheets 24,26 are of similar shape, and overlie one another. A tube 22 of knitted material is stitched to the periphery of the front and rear sheets 24,26, thereby also stitching the front and rear sheets 24,26 together, and a continuous, resilient hoop 28 is contained within the tube 22, as illustrated in FIG. 2.

The front sheet 24 of knitted fabric is of generally black colouration but its outwardly facing surface includes a central, rectangular, projection surface 25 of white colouration. In use, a projector projects an image onto this white projection surface 25.

The rear sheet 26 of the front panel 20 is of black colouration and acts to absorb light that is transmitted through the white projection surface 25. The provision of the rear sheet 26 of the front panel 20 is found to improve the quality of the image formed on the white projection surface 25.

The rear panel 30 comprises a single sheet 34 of knitted fabric, a tube 32 of knitted fabric stitched to the periphery of the single sheet 34, and a continuous, resilient hoop contained within the tube 32. The single sheet 34 of knitted fabric of the rear panel 30 is of black colouration.

The hoops 28 of the front and rear panels 20,30 are formed from a band of carbon spring steel, most preferably having a width of about 10 mm and the ends of which are riveted, welded or clipped together to form the hoop 28. The effect of the hoop 28 is to maintain the sheets 24,26,34 of fabric in a tensioned and slightly stretched state.

The stabilising members 40 are disposed between the lower edges of the two panels 20,30 (as viewed in FIG. 1) and aid the stability of the projection screen 10 when the screen 10 is erect. The stabilising members 40 are stitched at each end to the lower edge of the respective panel 20,30 and are hinged at their centre, as described in more detail below, so as to allow the panels 20,30 to be folded together after use.

FIG. 3a shows a stabilising member 40 in more detail. Each stabilising member 40 comprises a band of strong, inelastic fabric having an elongate pocket 42 extending longitudinally along each half of the member 40. These pockets 42 extend from opposing ends of the member 40 to positions beyond the centre of the member 40. Each pocket 42 encapsulates a rigid rod (not visible in FIGS. 1 and 3), eg a metal or rigid plastics rod, within its length.

The pockets 42 are stitched to the upper surface of the member 40 (as viewed in FIGS. 1 and 3) along their length as far as the centre of the member 40. The portion of the pocket 42 extending beyond the centre of the member 40 has a strip of touch-and-close material 44a (VELCRO-type material) fastened to its underside, and the member 40 has a corresponding strip of touch-and-close material 44b fastened to its upper surface, as shown in FIG. 3b. The strips of touch-and-close material 44a,44b maintain the member 40 in the position shown in FIG. 3a when the projection screen 10 is erect.

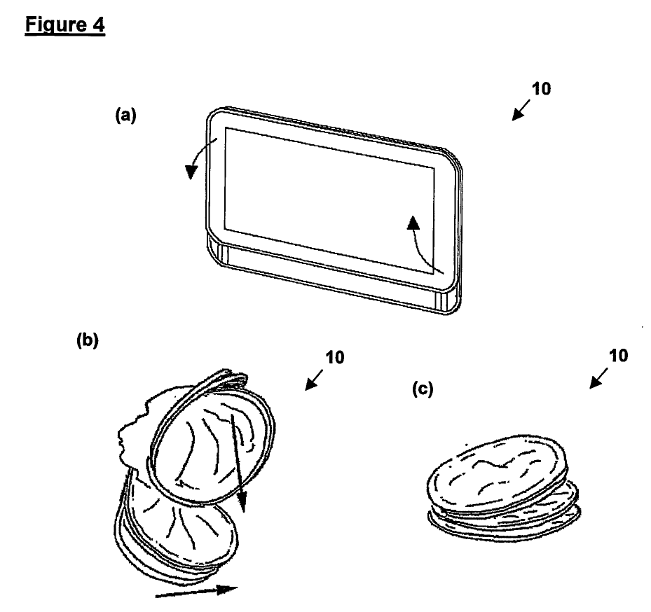

When it is desired to collapse the projection screen 10, the strips oftouch-and-close material 44a,44b of the stabilising members 40 are urged apart and the stabilising member 40 is folded about the centre of the member 40, as shown in FIGS. 3b and 3c. Turning now to FIG. 4, the panels 20,30 are folded together (FIG. 4a) whilst simultaneously folding the stabilising members 40 so that they lie between the panels 20,30, orientated parallel to the minor edges of the projection screen 10. The folded panels 20,30 are reduced further in size by grasping opposite sides of the panels 20,30 and twisting to form loops which can then be folded over (FIGS. 4b and 4c). The folded projection screen 10 can then be stowed in a pouch or other receptacle until it is next required.

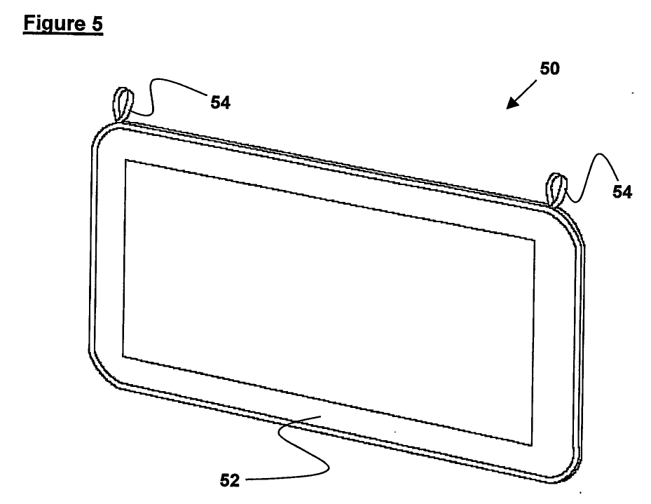

FIG. 5 shows a second embodiment of a projection screen according to the invention which is generally designated 50. The second embodiment 50 comprises a panel 52 that is identical to the front panel 20 of the first embodiment 10. However, unlike the first embodiment 10, the second embodiment 50 does not have a rear panel 30 or a stabilising member 40. Instead, the second embodiment 50 includes two loops of fabric 54, one at each end of the upper edge of the panel 52, by which the panel 52 is suspended during use. The second embodiment 50 is therefore suitable for hanging on a wall, for example.

The second embodiment 50 is collapsed in a similar manner to the first embodiment 10 by grasping opposite sides of the panel 52 and twisting to form loops which can then be folded over.

1. A collapsible projection screen comprising a projection layer formed of a flexible sheet of a knitted fabric, and a flexible hoop for supporting the projection layer in tension during use, wherein at least part of the tensioned projection layer has a front projection surface adapted to have an image projected thereon and a corresponding rear surface that is overlaid with a backing layer that absorbs light transmitted through the projection surface of the projection layer.

2. A collapsible projection screen as claimed in claim 1, wherein the tensioned projection layer is free of creases.

3. A collapsible projection screen as claimed in claim 2, wherein the projection layer is stretched slightly when tensioned.

4. (cancel)

5. A collapsible projection screen as claimed in claim 1, wherein the backing layer overlies the entire rear surface of the projection layer.

6. A collapsible projection screen as claimed in claim 1, wherein the backing layer is of black colouration.

7. A collapsible projection screen as claimed in claim 1, wherein the backing layer is formed of a sheet of fabric.

8. A collapsible projection screen as claimed in claim 1, wherein the facing surfaces of the projection layer and the backing layer are not bonded together but are held in close abutment.

9. (cancel)

10. A collapsible projection screen as claimed in claim 1, wherein the projection layer and backing layer are provided with a peripheral tube within which a flexible hoop is accommodated, the hoop serving to tension and slightly stretch the fabric of the projection layer and the backing layer.

11. A collapsible projection screen as claimed in claim 1, wherein the projection screen includes means by which the panel can be suspended during use.

12. A collapsible projection screen as claimed in claim 1, wherein the projection screen is self-supporting in an upright position.
